(19) United States
(12) Patent Application Publication
(10) Pub. No.: US 2020/0360865 A1
(43) Pub. Date: Nov. 19, 2020

(54) PETAL-LIKE INNER SUPPORT FRAME FOR USE IN TUBULAR FILTER MEMBRANE AND APPLICATION THEREOF

(71) Applicant: SHANGHAI MAITUO TECHNOLOGIES DEVELOPMENT CO., LTD., SHANGHAI (CN)

(72) Inventors: SIMIAO ZHOU, SHANGHAI (CN); SHUIYI ZHU, SHANGHAI (CN)

(21) Appl. No.: 16/944,221

(22) Filed: Jul. 31, 2020

Related U.S. Application Data
(63) Continuation of application No. PCT/CN2018/117633, filed on Nov. 27, 2018.

(30) Foreign Application Priority Data
Mar. 13, 2018 (CN) 201810202908.9

(51) Int. Cl. B01D 69/10; B01D 69/04; B01D 63/06

(52) U.S. Cl. CPC B01D 69/10; B01D 63/065; B01D 69/04

(57) ABSTRACT

A petal-like inner support frame for use in a tubular filter membrane and an application thereof. The support frame includes a central column and a plurality of support arms surrounding, the outside of the central column, the support arms extend along an axis of the central column, and a medium channel is formed between two adjacent support arms. The beneficial effects are: the structure can be processed by equipment at one time without multiple processing; the support frame installed in the tubular filter membrane can realize the enlargement and optimization of the cross sections of the medium channels, thereby improving the, filter efficiency of the filter membrane, obtaining a higher filtration flux of the filter membrane, and achieving a better filtration/separation effect.

### CROSS REFERENCE TO RELATED APPLICATIONS

The present application is a Continuing Application of PCT Application No. PCT/CN2018/117633 filed on Nov. 27, 2018, which claims the benefit of Chinese Patent Application No. 201810202908.9 filed on Mar. 13, 2018. All the above are hereby incorporated by reference.

### FIELD OF THE INVENTION

The present invention relates to the field of membrane filtration/membrane separation technology, and particularly to a petal-like inner support frame for use in a tubular filter membrane and an application thereof.

### BACKGROUND OF THE INVENTION

With the development of industrialization, a large amount of domestic and industrial wastewater is discharged into water bodies, so that water sources on which humans rely are increasingly polluted. On the other hand, fresh water sources that can be provided on the earth are increasingly scarce, more and more cities are enrolled in water shortage regions, and governments all over the world hope to improve the utilization of existing water resources through the advanced treatment and reuse of industrial wastewater and domestic wastewater. Membrane separation technology has been gradually promoted and applied due to its advantages of high separation efficiency, simple equipment, convenient operation, no phase change, energy conservation, etc. The common filter membrane is a hollow fiber membrane, generally including a filter membrane body provided with a through hole throughout its length direction. Such a membrane is relatively fragile, and, is easy to rupture due to the impact of water when applied to a filter device, so the service life is short. In order to prevent the rupture of the filter membrane, support materials are often added in tubular filter membranes in the prior art. For example, common braided inner supports, cylindrical rubber, etc. are added, and their structures are all cylindrical tubular profiles. In order to increase the filtering effect, holes need to be formed in their cylindrical tube walls by secondary processing methods. The secondary processing methods include but are not limited to: drilling, punching, stretching into holes, weaving into holes, etc.

However, due to the large contact area between the inner support and the tubular filter membrane, the medium is subjected to a large additional resistance during the filtration/separation process, which is not conducive to improving the working performance and efficiency of filtration/separation of the tubular membrane.

Therefore, the present invention provides a petal-like inner support frame for use in a tubular filter membrane and an application thereof, and the petal-like inner support frame does not need multiple processing, and is convenient to install and good in filtration/separation effect.

### SUMMARY OF THE INVENTION

The present invention provides a petal-like inner support frame for use in a tubular filter, membrane to solve the problems of poor filtration/ separation effect, multiple processing requirements, complicated operations, etc. in the prior art.

The technical problems to be solved by the present invention are solved using the following technical solutions:

A petal-like inner support frame for use in a tubular filter membrane comprises a central column and a plurality of support arms surrounding the outside of the central column, the support arms extend along an axis of the central column, and a medium channel is formed between two adjacent support arms.

As a preferred technical solution a tail end of the support arm has a support arm end portion, and the cross section of the support arm end portion is in any shape such as arc, semicircle, triangle, polygon, or irregular curve.

As a preferred technical solution, the tail end of each support arm is provided with more than two first bifurcated arms, a tail end of the, first bifurcated arm has a bifurcated end portion, and the cross section of the bifurcated end portion is in any shape such as arc, semicircle, triangle. polygon, or irregular curve.

As a preferred technical solution, the cross section of the central column is in any shape such as circle, ellipse, triangle, polygon, or irregular curve.

As a preferred technical solution, the support arms are distributed at equal intervals on the outside of the central column.

As a preferred technical solution, the support arms are distributed at non-equal intervals on the outside of the central column.

As a preferred technical solution, the number of the support arms is 3 or more.

As a preferred technical solution, the support arm end portion is provided with an arc-shaped support surface.

As a preferred technical solution, the bifurcated end portion is provided with an arc-shaped support surface.

The present invention also provides an application of the petal-like inner support frame for use in a tubular filter membrane, and the support frame is used in, the tubular filter membrane. The support arm end portions of the support frame abut against the inner wall of, the tubular filter membrane.

The present invention has the beneficial effects: the structure can be processed by equipment at one time without multiple processing; the support frame installed in the tubular filter membrane can realize the enlargement and optimization of the cross sections of the medium channels, thereby improving the filter efficiency of the filter membrane, obtaining a higher filtration flux of the filter membrane, and achieving a better filtration/separation effect.

### BRIEF DESCRIPTION OF THE DRAWINGS

In order to describe the technical solutions in the embodiments of the present invention or in the prior art more clearly, the drawings which need to be used in the description of the embodiments or the prior art will be simply introduced below. Obviously, the drawings in the following description show merely some embodiments of the present invention, and those of ordinary skill in the art may still derive other drawings according to these drawings without creative efforts.

FIG. 1 is a first schematic structural diagram of a petal-like inner support frame for use in a tubular filter membrane according to the present invention;

FIG. 2 is a second schematic structural diagram of a petal-like inner support frame for use in a tubular filter membrane according to the present invention;

FIG. 3 is a third schematic structural diagram of a petal-like inner support frame for use in a tubular filter membrane according to the present invention;

FIG. 4 is a fourth schematic structural diagram of a petal-like inner support frame for use in a tubular filter membrane according to the present invention;

FIG. 5 is a fifth schematic structural diagram of a petal-like inner support frame for use in a tubular filter membrane according to the present invention;

FIG. 6 is a sixth schematic structural diagram of a petal-like inner support frame for use in a tubular filter membrane according to the present invention;

FIG. 7 is a seventh schematic structural diagram of a petal-like inner support frame for use in a tubular filter membrane according to the present invention.

### DETAILED DESCRIPTION OF THE EMBODIMENTS

In order to easily understand the technical means, creative features, objectives and effects of the present invention, the present invention will be further explained below with reference to the specific drawings.

### Embodiment 1

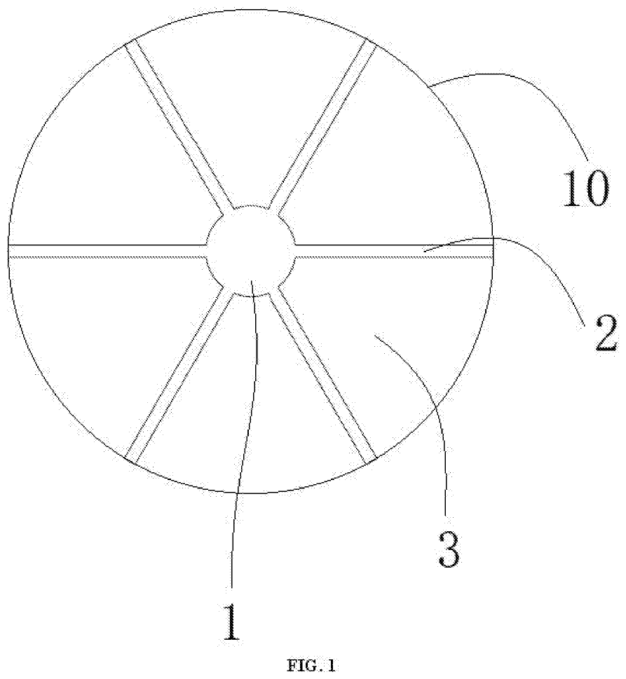

Referring to FIGS. 1-6, a petal-like inner support, frame for use in a tubular filter membrane includes a central column 1 and a plurality of support arms 2 surrounding the outside of the central column 1, the support arms 2 extend along an axis of the central column 1, and a medium channel 3 is formed between two adjacent support arms 2. The number of support arms 2 is generally three or more, and the number of support arms 2 in this embodiment is six. The more the number of support arms 2 is, the better the effect of making a tubular filter membrane 10 arranged outside it will be, and the rupture of the filter membrane 10 can be effectively prevented. However, too many support arms 2 will reduce the area of the medium channels 3 and decrease the filtration/separation effect. Therefore, an appropriate number of support arms 2 should be selected.

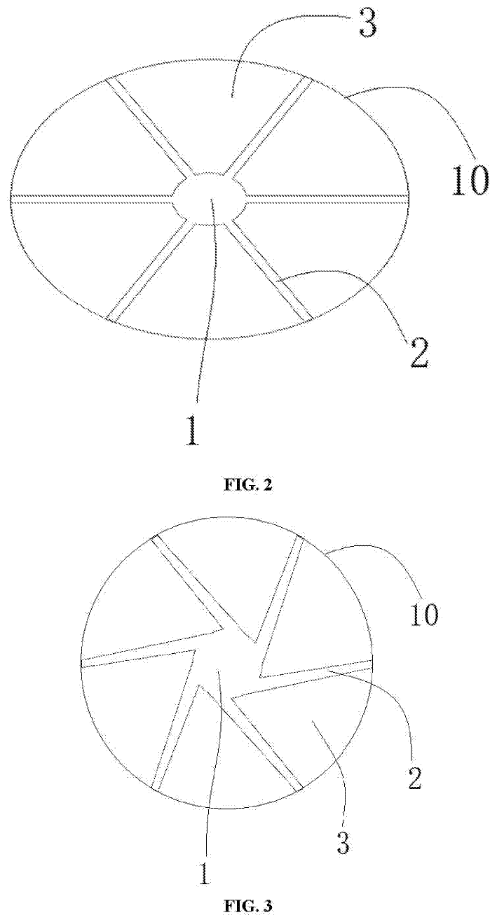

The cross section of the central column 1 in the present invention is in any shape such as circle, ellipse, triangle, polygon, or irregular curve. The specific shape selection of the cross section of the central column 1 is related to the diameter and shape of the filter membrane 10 and the number of support arms 2. For example, the cross section of the central column 1 in FIG. 1 in this embodiment is circular, which is suitable for a circular filter membrane 10; and the cross section of the central column 1 in FIG. 2 is elliptical, which is suitable for an elliptical filter, membrane 10. The central column 1 of a polygonal structure in FIG. 3 has strong stability.

As shown in FIG. 4, the support arms 2 in the present invention may be distributed at equal intervals on the outside of the central column 1. The support arms 2 distributed at equal intervals can be used in a filter device with stable filtrate, which is beneficial to achieving a better filtration/separation effect.

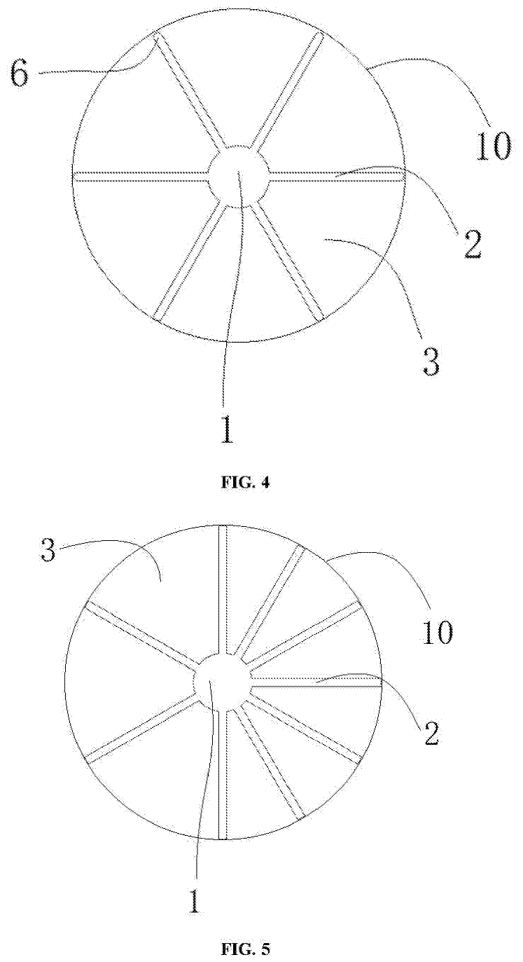

As shown in FIG. 5, the support arms 2 in the present invention may be distributed at non-equal intervals on the outside of the central column 1. The support aims 2 distributed at non-equal intervals can be used in a filter device in which the filtrate is in a flowing state, which is beneficial to achieving a better filtration/separation effect.

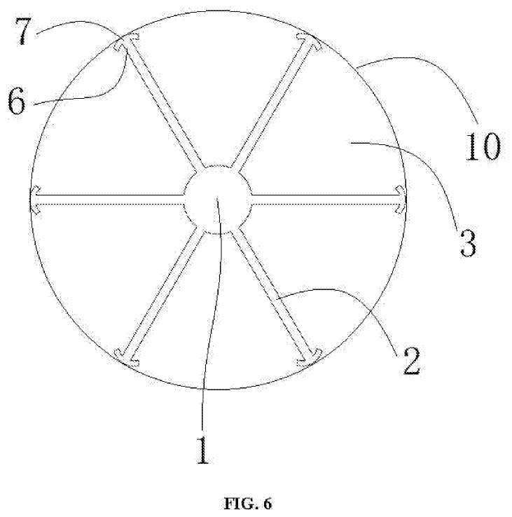

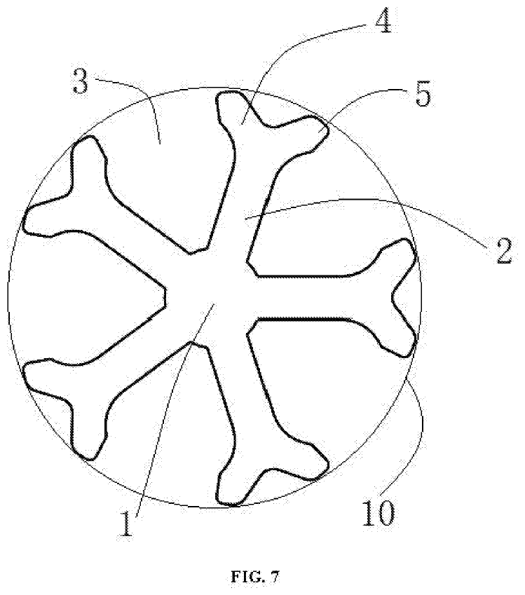

As shown in FIG. 6, a tail end of the support arm 2 of the present invention has a support arm end portion 6, and the cross section of the support arm end portion 6 is in any shape such as arc, semicircle, triangle, polygon, or irregular curve. Since the support arm end portions 6 are in direct contact with the filter membrane 10, the support arm end portions 6 in different shapes have different supporting effects. In order to better support the filter membrane 10, the support arm end portion 6 is provided with an arc-shaped support surface 7, and due to its large contact surface, the support effect is good and the rupture of the filter membrane 10 is effectively prevented.

### Embodiment 2

Referring to FIG. 7, the differences from the Embodiment 1 are that the tail end of each support arm 2 is provided with more than two first bifurcated arms 4, a tail end of the first bifurcated arm 4 has a bifurcated end portion 5, and the cross section of the bifurcated end portion 5 is in any shape such as arc, semicircle, triangle, polygon, or irregular curve.

In order to better support the filter membrane 10, the bifurcated end portion 5 is provided with an arc-shaped support surface (not shown), and due to its large contact surface, the support effect is good and the rupture of the filter membrane 10 is effectively prevented.

The petal-like inner support frame for use in a tubular filter membrane 10 according to the present invention is in a petal-like structural shape formed by one-time processing, has a simple structure, is made of various metal materials (including but not limited to: stainless steel, titanium, aluminum, etc.) or non-metallic materials (including but not limited to: various engineering plastics, such as ABS/PP/M/PVC/CPVC/PTFE/PVDF/ . . . ; various rubbers, such as lEPDM/fluorine rubber/natural rubber/ . . . ) according to, different application condition demands, and, meanwhile can be produced by different processing techniques (including but not limited to: machining molding, casting molding, injection molding, extrusion molding, etc.). Therefore, it has wider applicability and can meet the application needs of the industry.

According to different tubular filter membranes 10, it can be applied to filtration & separation of gas and gas, filtration & separation of gas and liquid, filtration & separation of gas and solid, filtration & separation of liquid and solid, with a wide application range.

Since the medium channel 3 is formed between two adjacent support arms 2, the effective area ratio of the medium channel 3 is increased, and the resistance in the medium channel 3 is greatly reduced to the greatest extent at the same time, which can achieve an excellent filtration/separation effect.

The present invention also protects an application of the petal-like inner support frame for use in a tubular filter membrane, and the support frame is used in the tubular filter membrane. As shown in FIGS. 4 and 6, the support arm end portions 6 of the support frame abut against the inner wall of the filter membrane 10.

The above shows and describes the basic principles, main features and advantages of the present invention. It should be understood by those skilled in the art that the present invention is not limited to the embodiments described above, the above-mentioned embodiments and the description are only for explaining the principle of the present invention, various changes and improvements may also be made to the present invention without departing from the spirit and scope of the present invention, and all these changes and improvements fall within the scope of the present invention. The scope of the present invention is defined by the appended claims and equivalents thereof.

1. A petal-like inner support frame for use in a tubular filter membrane, comprising a central column and a plurality of support arms surrounding the outside of the central column, the support arms extend along an axis of the central column, and a medium channel is formed between two adjacent support arms.

2. The petal-like inner support frame for use in a tubular filter membrane according to claim 1, wherein a tail end of the support arm has a support arm, end portion, and the cross section of the support arm end portion is in any shape such as arc semicircle, triangle, polygon, or irregular curve.

3. The petal-like inner support frame for use in a tubular filter membrane according to claim 2, wherein the tail end of each support arm is provided with more than two first bifurcated arms, a tail end of the first bifurcated and has a bifurcated end portion, and the cross section of the bifurcated end portion is in any shape such as arc, semicircle, triangle polygon, or irregular curve.

4. The petal-like inner support frame for use in a tubular filter membrane according to claim 1, wherein the cross section of the central column is in any shape such as circle, ellipse, triangle, polygon, or irregular curve.

5. The petal-like inner support frame for use in a tubular filter, membrane according to claim 1, wherein the support arms are distributed at equal intervals on the outside of the central column.

6. The petal-like inner support frame for use in a tubular filter membrane according to claim 1, wherein the support, arms are distributed at non-equal intervals on the outside of the central column.

7. The petal-like inner support frame for use in a tubular filter membrane according to claim 1, wherein the number of the, support arms is 3 or more.

8. The petal-like inner support frame for use in a tubular filter membrane according to claim 2, wherein the support arm end portion is provided with an arc-shaped support surface.

9. The petal-like inner support, frame for use in a tubular filter membrane according to claim 3, wherein the bifurcated end portion is provided with an arc-shaped support surface.

10. The petal-like inner support frame for use in a tubular filter membrane according to claim 2, wherein the support arm end portions of the support, frame abut against the inner wall of the tubular filter membrane.

11. An application of the petal-like inner support frame for use in a tubular filter membrane, wherein the support frame according to claim 1 is used in the tubular filter membrane.

12. An application of the petal-like inner support frame for use in a tubular filter membrane, wherein the support frame according to claim 2 is used in the tubular filter membrane.

13. An application of the petal-like inner support frame for use in a tubular filter membrane, wherein the support frame according to claim 3 is used in the tubular filter membrane.

14. An application of the petal-like inner support frame for use in a tubular filter membrane, wherein the support frame according to claim 4 is used in the tubular filter membrane.

15. An application of the petal-like inner support frame for use in a tubular filter membrane, wherein the support frame according to claim 5 is used in the tubular filter membrane.

16. An application of the petal-like inner support frame for use in a tubular filter membrane, wherein the support frame according to claim 6 is used in the tubular filter membrane.

17. An application of the petal-like inner support frame for use in a tubular filter membrane, wherein the support frame according to claim 7 is used in the tubular filter membrane.

18. An application of the petal-like inner support frame for use in a tubular filter membrane, wherein the support frame according to claim 8 is used, in the tubular filter membrane.

19. An application of the petal-like inner support frame for use in a tubular filter membrane, wherein the support frame according to claim 9 is used in the tubular filter membrane.

20. An application of the petal-like inner support frame for use in a tubular filter membrane, wherein the support frame according to claim 10 is used in the tubular filter membrane.
